(19) United States
(12) Patent Application Publication
(10) Pub. No.: US 2012/0268365 A1
(43) Pub. Date: Oct. 25, 2012

(54) METHOD, SYSTEM, AND APPARATUS FOR CONTROLLING LIGHT

(76) Inventors: Sang-gon LEE, Seoul (KR); Ki-young KIM, Gyeonggi-do (KR); Sang-hun LEE, Gyeonggi-do (KR); Chang-sub LEE, Seoul (KR)

(21) Appl. No.: 13/451,300

(22) Filed: Apr. 19, 2012

(30) Foreign Application Priority Data
Apr. 19, 2011 (KR) 10-2011-0036388
Apr. 19, 2011 (KR) 10-2011-0036389
Jan. 2, 2012 (KR) 10-2012-0000171

(51) Int. Cl. G09G 5/00

(52) U.S. Cl. 345/156

(57) ABSTRACT

Methods, systems and apparatuses for controlling light. A method of controlling light includes displaying on a display unit at least one light property representing a property of the light of a lighting apparatus; if a user command for selecting a property value of the light property is input, displaying a lighting state corresponding to the selected property value; and if a user command representing that selection is completed is input, determining the displayed lighting state as a lighting state of the lighting apparatus.

### CROSS-REFERENCE TO RELATED APPLICATIONS

This application claims the benefits of Korean Patent Application No. 10-2011-0036388, filed on Apr. 19, 2011, Korean Patent Application No. 10-2011-0036389, filed on Apr. 19, 2011, and Korean Patent Application No. 10-2012-0000171, filed on Jan. 2, 2012, in the Korean Intellectual Property Office, the disclosures of which are incorporated herein in their entirety by reference.

### BACKGROUND

1. Field

The present disclosure relates to methods, systems and apparatuses for controlling light of a lighting apparatus.

2. Description of the Related Art

Light-emitting diodes are light-emitting elements manufactured using a semiconductor manufacturing process. The light-emitting diodes started to be commercialized at the end of the 1960s after a light-emitting phenomenon was observed by applying a voltage to a semiconductor device in the 1920s. Since then, technologies for improving the efficiency of light-emitting diodes have been continuously researched and developed, and interest in light-emitting diodes having optical characteristics capable of replacing existing incandescent bulbs are increasing.

Recently, a light control system using light-emitting diodes having brightness characteristics equal to those of existing light control systems has been presented. However, much research is still needed on light-emitting diodes, packages of light-emitting diodes, optical systems including light-emitting diodes, and apparatuses for controlling light-emitting diodes.

Furthermore, since lighting states of currently commercialized light control systems are previously determined according to usage of the light control systems when the light control systems are manufactured, a user is merely able to power on or off the light control systems and is not able to operate the light control systems in various ways.

### SUMMARY

Provided are methods and apparatuses for controlling light of a lighting apparatus based on a network.

Provided are methods and apparatuses for controlling light to variously change the light according to the senses of a user or variations of an ambient environment.

Provided are methods and apparatuses for controlling light according to the position of the apparatuses.

Additional aspects will be set forth in part in the description which follows and, in part, will be apparent from the description, or may be learned by practice of the presented embodiments.

According to an aspect of the present invention, a method of controlling light includes displaying on a display unit at least one light property representing a property of the light of a lighting apparatus; if a user command for selecting a property value of the light property is input, displaying a lighting state corresponding to the selected property value; and if a user command representing that selection is completed is input, determining the displayed lighting state as a lighting state of the lighting apparatus.

The light property may be information regarding color, brightness, color temperature, or dimming cycle of the light emitted from the lighting apparatus.

When the light property is displayed, a current lighting state of the lighting apparatus may be also displayed on the display unit.

The light property may be displayed as a plurality of property values corresponding to the light property.

The light property may include a first light property and a second light property, and the method may further include, if a user command for selecting a first property value of the first light property is input, displaying a plurality of property values of the second light property related to the first property value.

The first light property may be color, and the second light property may be brightness.

The plurality of property values of the second light property may include the first property value and property values of the second light property which sequentially vary with respect to the first property value.

The method may further include displaying a first lighting state, the light property may include a plurality of color icons representing colors of the light, and the displaying of the lighting state may include, if a user command for selecting at least one of the plurality of color icons is input as the user command for selecting the property value, displaying a second lighting state obtained by calculating a color corresponding to the selected color icon onto the first lighting state, instead of the first lighting state on the display unit.

The first lighting state may be a current lighting state or a previous lighting state of the lighting apparatus.

The displaying of the second lighting state may include generating a second lighting code by calculating a predetermined color code onto a first lighting code corresponding to the first lighting state; and displaying the second lighting state corresponding to the second lighting code.

The plurality of color icons may include a first color icon representing a first color and a second color icon representing a second color, and each of the first and second lighting codes may include a first code region representing the first color and a second code region representing the second color.

If a user command for selecting the first color icon is input, the predetermined color code may be calculated onto the first code region and, if a user command for selecting the second color icon is input, the predetermined color code may be calculated onto the second code region.

The color may be red, green, or blue.

The light property may include a brightness icon representing a brightness level of the light, and the displaying of the lighting state may further include, if a user command for selecting the brightness icon is input as the user command for selecting the property value, displaying a third lighting state obtained by calculating a brightness level corresponding to the selected brightness icon onto the second lighting state, instead of the second lighting state on the display unit.

The brightness icon may be displayed as at least one of black, white, and an achromatic color.

The displaying of the third lighting state may include generating a third lighting code by calculating a predetermined brightness code onto a second lighting code corresponding to the second lighting state; and displaying the third lighting state corresponding to the third lighting code on the display unit.

Each of the second and third lighting codes may include a first code region representing the first color and a second code region representing the second color and, if a user command for selecting the brightness icon is input, the predetermined brightness code may be calculated onto each of the first and second code regions.

The method may further include, if a user command for requesting to execute the lighting state is input, transmitting to the lighting apparatus an execution request message for requesting to execute the determined lighting state.

The method may further include, if a user command for selecting the lighting apparatus is input, obtaining identification information of the lighting apparatus; and storing the identification information of the lighting apparatus by matching the identification information to information regarding the lighting state.

The identification information of the lighting apparatus may include a static Internet protocol (IP) address of the lighting apparatus.

The method may further include, if the lighting apparatus is communicable, transmitting to the lighting apparatus a message for requesting to execute the lighting state.

The lighting apparatus is communicable via a relay apparatus.

The relay apparatus may be an access point (AP).

The identification information of the lighting apparatus may include identification information and port information of the relay apparatus for forwarding a port to the lighting apparatus.

The identification information of the relay apparatus may include a static IP address of the relay apparatus.

The identification information of the relay apparatus may include domain information of the relay apparatus.

The method may further include receiving a message representing that the lighting state is executed, from the lighting apparatus via the relay apparatus; and displaying on the display unit an indicator representing that the lighting state is completely executed.

The method may further include, if the communication with the lighting apparatus is disconnected, displaying on the display unit an indicator representing that the execution of the lighting state is terminated.

According to another aspect of the present invention, a control apparatus includes a display unit for displaying on a display unit at least one light property representing a property of light of a lighting apparatus; a user input unit for receiving a user command for selecting a lighting state of the lighting apparatus; and a control unit for, if a user command for selecting a property value of the light property is input, displaying a lighting state corresponding to the selected property value on the display unit and, if a user command representing that selection is completed is input, determining the displayed lighting state as the lighting state of the lighting apparatus.

The light property may be information regarding color, brightness, color temperature, or dimming cycle of the light emitted from the lighting apparatus.

The control unit may display a current lighting state of the lighting apparatus on the display unit.

The light property may be displayed as a plurality of property values corresponding to the light property.

The light property may include a first light property and a second light property and, if a user command for selecting a first property value of the first light property is input, the control unit may display a plurality of property values of the second light property related to the first property value on the display unit.

The first light property may be color, and the second light property is brightness.

The plurality of property values of the second light property may include the first property value and property values of the second light property which sequentially vary with respect to the first property value.

The light property may include a plurality of color icons representing colors of the light, a first lighting state may be displayed on the display unit and, if a user command for selecting at least one of the plurality of color icons is input as the user command for selecting the property value, the control unit may display a second lighting state obtained by calculating a color corresponding to the selected color icon onto the first lighting state, instead of the first lighting state on the display unit.

The first lighting state may be a current lighting state or a previous lighting state of the lighting apparatus.

The control unit may generate a second lighting code by calculating a predetermined color code onto a first lighting code corresponding to the first lighting state, and may display the second lighting state corresponding to the second lighting code.

The plurality of color icons may include a first color icon representing a first color and a second color icon representing a second color, and each of the first and second lighting codes may include a first code region representing the first color and a second code region representing the second color.

If a user command for selecting the first color icon is input, the control unit may calculate the predetermined color code onto the first code region and, if a user command for selecting the second color icon is input, the control unit may calculate the predetermined color code onto the second code region.

The light property may include a brightness icon representing a brightness level of the light and, if a user command for selecting the brightness icon is input as the user command for selecting the property value, the control unit may display a third lighting state obtained by calculating a brightness level corresponding to the selected brightness icon onto the second lighting state, instead of the second lighting state on the display unit.

The brightness icon may be displayed as at least one of black, white, and an achromatic color.

The control unit may generate a third lighting code by calculating a predetermined brightness code onto a second lighting code corresponding to the second lighting state, and may display the third lighting state corresponding to the third lighting code on the display unit.

Each of the second and third lighting codes may include a first code region representing the first color and a second code region representing the second color and, if a user command for selecting the brightness icon is input, the control unit may calculate the predetermined brightness code onto each of the first and second code regions.

If a user command for requesting to execute the lighting state is input, the control unit may transmit to the lighting apparatus an execution request message for requesting to execute the determined lighting state.

If a user command for selecting the lighting apparatus is input, the control unit may obtain identification information of the lighting apparatus, and may store in a storage the identification information of the lighting apparatus by matching the identification information to information regarding the lighting state.

The identification information of the lighting apparatus may include a static Internet protocol (IP) address of the lighting apparatus.

If the lighting apparatus is communicable, the control unit may transmit to the lighting apparatus a message for requesting to execute the lighting state.

The lighting apparatus may be communicable via a relay apparatus.

The relay apparatus may be an access point (AP).

The identification information of the lighting apparatus may include identification information and port information of the relay apparatus for forwarding a port to the lighting apparatus.

The identification information of the relay apparatus may include a static IP address of the relay apparatus.

The identification information of the relay apparatus may include domain information of the relay apparatus.

If a message representing that the lighting state is executed is received from the lighting apparatus via the relay apparatus, the control unit may display on the display unit an indicator representing that the lighting state is completely executed.

If the communication with the lighting apparatus is disconnected, the control unit may display on the display unit an indicator representing that the execution of the lighting state is terminated.

The control apparatus may be a mobile device.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic diagram of a system for controlling light, according to an embodiment of the present invention;

FIG. 2 is a block diagram of a control apparatus according to an embodiment of the present invention;

FIG. 3 is a block diagram of a relay apparatus according to an embodiment of the present invention;

FIG. 4 is a block diagram of a lighting apparatus according to an embodiment of the present invention;

FIG. 5 is a flowchart of a method of setting a lighting state of a lighting apparatus by using a control apparatus, according to an embodiment of the present invention;

FIGS. 6A through 6E are images of a user interface for setting a lighting state, according to an embodiment of the present invention;

FIG. 7 is a flowchart of a method of setting a lighting state of a lighting apparatus in a user mode, according to an embodiment of the present invention;

FIGS. 8A and 8B are images of a user interface for setting a lighting state in a user mode, according to an embodiment of the present invention;

FIG. 9 is a flowchart of a method of changing the color of a lighting state, according to an embodiment of the present invention;

FIG. 10 is a flowchart of a method of changing the brightness of a lighting state, according to an embodiment of the present invention;

FIGS. 11A through 11C are images of a user interface for setting a lighting state in a user mode, according to another embodiment of the present invention;

FIGS. 12A and 12B are an image and a table, respectively, showing correlations between lighting states and lighting codes, according to an embodiment of the present invention;

FIG. 13 is a flowchart of a method of registering a lighting apparatus to automatically execute a lighting state, according to an embodiment of the present invention; and

FIG. 14 is a flowchart of a method of requesting to execute a lighting state by a control apparatus, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, expressions such as “at least one of,” when preceding a list of elements, modify the entire list of elements and do not modify the individual elements of the list.

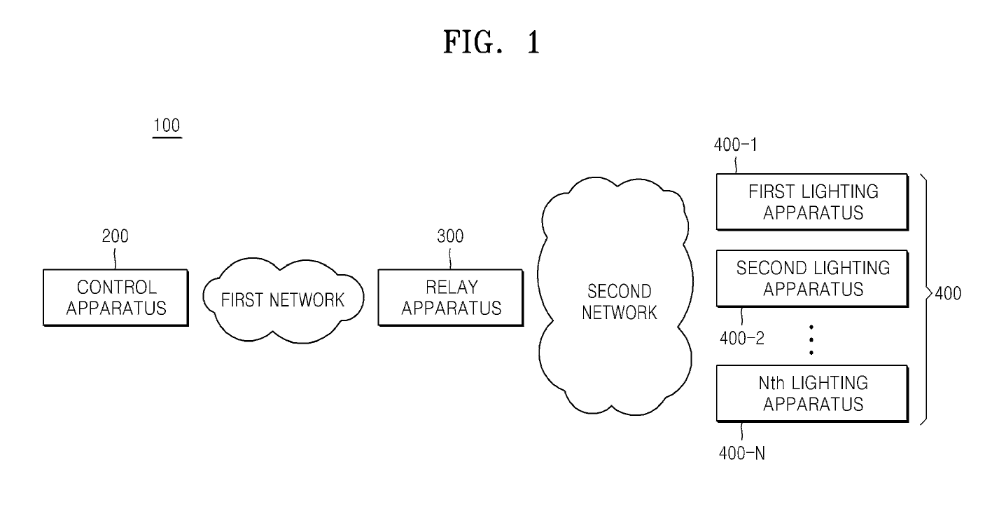

FIG. 1 is a schematic diagram of a system 100 for controlling light, according to an embodiment of the present invention. Referring to FIG. 1, the system 100 includes a control apparatus 200 for generating a control message for controlling light, and at least one lighting apparatus 400 for generating light according to the control message. Also, the system 100 may further include a relay apparatus 300 for relaying communication between the control apparatus 200 and the lighting apparatus 400.

If the relay apparatus 300 is included in the system 100, the control apparatus 200 and the relay apparatus 300 may be connected in a first network, and the relay apparatus 300 and the lighting apparatus 400 may be connected in a second network. Each of the first and second networks may be the Internet, a mobile communication network, or a local area network (LAN). The first and second networks may be of the same type or different types. Alternatively, the control apparatus 200 may directly control light of the lighting apparatus 400 without using the relay apparatus 300.

The control apparatus 200 is a device, for example, a mobile device, that is spatially separate from the lighting apparatus 400 and is capable of controlling the lighting apparatus 400 by wire or wireless communication. For convenience of explanation, it is assumed in the current embodiment that the control apparatus 200 is a mobile device. The mobile device may be a mobile phone, a smart phone, a notebook computer, a digital broadcasting terminal, a personal digital assistant (PDA), a portable multimedia player (PMP), a vehicle navigator, or a remote controller.

The relay apparatus 300 is a device, e.g., an access point (AP) or a gateway, which performs wire or wireless communication with the control apparatus 200 and transmits to the lighting apparatus 400 the control message received from the control apparatus 200. Although the relay apparatus 300 is separate from the control apparatus 200 and the lighting apparatus 400 in FIG. 1, the current embodiment is not limited thereto. The relay apparatus 300 may be an element of the lighting apparatus 400 or may not be included in the system 100.

The lighting apparatus 400 is a device for emitting light and generating a certain lighting state. The lighting apparatus 400 may include a plurality of light-emitting elements for providing various colors and brightness levels. The light-emitting elements may be light-emitting diodes, but are not limited thereto, and may be fluorescent lamps, or light-emitting diodes and fluorescent lamps. The system 100 may include a plurality of lighting apparatuses 400, and the control apparatus 200 may selectively control at least one of the lighting apparatuses 400.

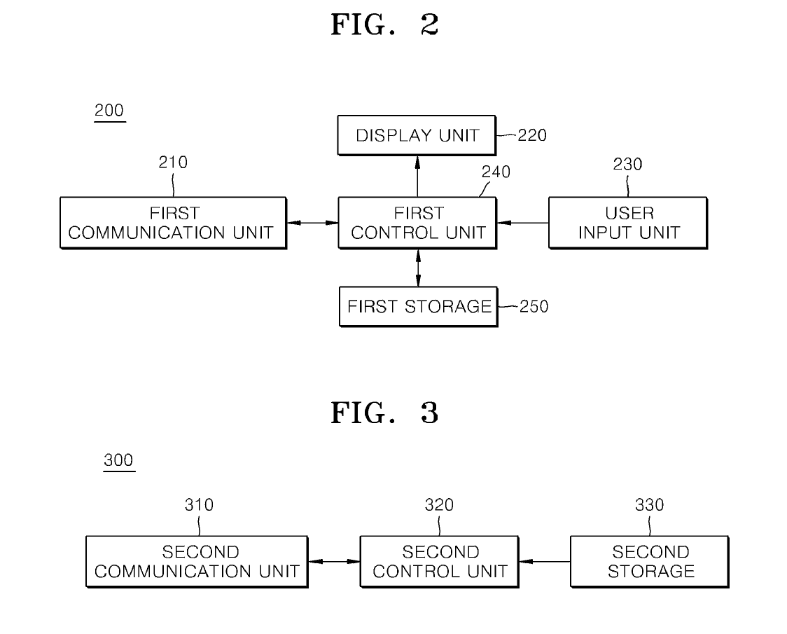

FIG. 2 is a block diagram of the control apparatus 200 according to an embodiment of the present invention.

Referring to FIGS. 1 and 2, the control apparatus 200 may include a first communication unit 210 for wirelessly communicating with the relay apparatus 300, a display unit 220 for displaying a lighting state of the lighting apparatus 400 or a result according to a user command, a user input unit 230 for inputting a user command to set the lighting state of the lighting apparatus 400, and a first control unit 240 for generating a control message according to the user command.

Here, light properties are basic elements representing light, and may include color, brightness, color temperature, and dimming cycle of the light. A light property may include a plurality of property values. That is, property values refer to different levels of a light property. For example, if a light property is color, color components such as red, green, and blue correspond to property values. The light properties and the property values are determined according to the intensity of light emitted from at least one light-emitting element.

The first communication unit 210 may include a mobile communication module, a wireless Internet module, and a short-distance communication module. The mobile communication module transmits or receives a wireless signal to or from at least one of a base station, an external terminal, and a server in a mobile communication network. The wireless Internet module is a module for wirelessly accessing the Internet, and may be included in or outside the control apparatus 200. The short-distance communication module is a module for short-distance communication, and may include a wireless LAN card.

The wireless LAN card may enable at least one wireless communication method according to the 802.11 standard for wireless LANs including wireless LANs and some infrared communication, the 802.15 standard for wireless personal area networks (PANs) including Bluetooth, ultra-wideband (UWB), and ZigBee, the 802.16 standard for wireless metropolitan area networks (MANs) including fixed wireless access (FWA), or the 802.20 standard for a wireless mobile broadband wireless access (MBWA) including Wibro and WiMAX, which were developed by the Institute of Electrical and Electronics Engineers (IEEE).

The first communication unit 210 communicates with the relay apparatus 300 by using at least one of the mobile communication module, the wireless Internet module, and the short-distance communication module. Hereinafter, a communication method used when the first communication unit 210 communicates with the relay apparatus 300 may not be specifically mentioned.

The user input unit 230 generates input data of a key input by a user to control an operation of the control apparatus 200. The user input unit 230 may be a key pad or a touch pad. In particular, if the touch pad forms a layered structure together with the display unit 220, the layered structure may be referred to as a touch screen.

The display unit 220 displays information processed by the control apparatus 200. For example, the display unit 220 may display, for example, a list of lighting apparatuses 400 and a list of light modes.

If the display unit 220 forms a layered structure together with the touchpad to form the touch screen as described above, the display unit 220 may be used as an input device as well as an output device. If the display unit 220 forms the touch screen, the display unit 220 may include a touch screen panel and a touch screen panel controller. In this case, the touch screen panel is a transparent panel bonded outside the control apparatus 200, and may be connected to an internal bus of the control apparatus 200. The touch screen panel monitors touches and, if touches are input, transmits signals corresponding to the touches to the touch screen panel controller. The touch screen panel controller processes the signals and transmits data corresponding to the signals to the first control unit 240 such that the first control unit 240 determines whether the touches are input and which regions of the touch screen are touched.

Also, the display unit 220 may include at least one of a liquid crystal display, a thin film transistor-liquid crystal display, an organic light-emitting diode, a flexible display, a transparent display, and a three-dimensional (3D) display.

The control apparatus 200 may further include a first storage 250 for storing a program for processing and controlling the first control unit 240, and for temporarily storing input or output data.

The first storage 250 may include at least one storing medium from among flash memory, hard disk memory, multimedia card micro memory, card memory (e.g., a secure digital (SD) card or an extreme digital (XD) card), random access memory (RAM), and read only memory (ROM).

Also, the first storage 250 may store information regarding light modes of the lighting apparatus 400. Here, the light modes may include a user mode in which a user directly selects property values of light properties to set a lighting state, a scene mode in which property values of light properties are pre-determined for every scene and a lighting state corresponding to a certain scene is set by selecting the certain scene, and a power mode for powering on or off the lighting apparatus 400. The scene mode may include sub-modes such as a read mode, a chat mode, a creative mode, a work mode, a study mode, a relax mode, a sleep mode, a desk lamp mode, an alarm mode, a method mode, a picture frame mode, and a game mode.

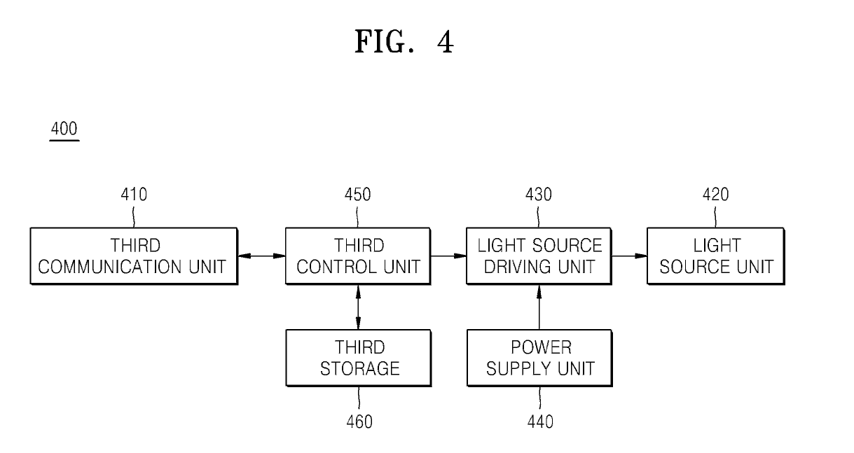

FIG. 3 is a block diagram of the relay apparatus 300 according to an embodiment of the present invention. As illustrated in FIG. 3, the relay apparatus 300 may include a second communication unit 310 for communicating with the control apparatus 200 and the lighting apparatus 400, and a second control unit 320 for generating various messages relayed between the control apparatus 200 and the lighting apparatus 400.

The second communication unit 310 functions the same as the first communication unit 210 of the control apparatus 200 illustrated in FIG. 2 and thus a detailed description thereof will not be provided here.

If an event for a communication connection occurs from an external device such as the control apparatus 200 or the lighting apparatus 400, the second control unit 320 may connect the external device to the relay apparatus 300. The second control unit 320 may allocate an Internet protocol (IP) address to the external device. Also, the second control unit 320 performs a relay function for a communication connection between external devices, or performs a relay function for a communication connection between an external device and an external communication network.

If external devices that are relay targets have different communication protocols, the second control unit 320 may convert the communication protocols of the external devices. For example, if the control apparatus 200 has a communication protocol based on the 802.11 standard and the lighting apparatus 400 has a communication protocol based on the 802.15 standard, the second control unit 320 may convert a message received from the control apparatus 200 to a protocol processable by the lighting apparatus 400 and may transmit the message to the lighting apparatus 400. As described above, if the control apparatus 200 and the lighting apparatus 400 have different communication protocols, the relay apparatus 300 may have a plurality of communication modules for communication in different protocols.

Also, the second control unit 320 may store information regarding the external device that is a relay target in a second storage 330. The information regarding the external device includes identification information of the external device, e.g., an IP address, a media access control (MAC) address, a product name, and function information of the external device. If the external device is the lighting apparatus 400, information regarding a space where the lighting apparatus 400 exists may also be stored in the second storage 330. In addition, information regarding a communication protocol of the external device may also be stored in the second storage 330.

Although the relay apparatus 300 is one device in FIG. 3, the current embodiment is not limited thereto. The relay apparatus 300 may be a combination of devices such as a gateway, an AP, and a server. Also, the control apparatus 200 may directly control the lighting apparatus 400 without using the relay apparatus 300. However, hereinafter, for convenience of explanation, a device(s) for relaying communication between the control apparatus 200 and the lighting apparatus 400 may be integrally referred to as the relay apparatus 300.

FIG. 4 is a block diagram of the lighting apparatus 400 according to an embodiment of the present invention. Referring to FIG. 4, the lighting apparatus 400 may include a third communication unit 410 for communicating with the relay apparatus 300 or the control apparatus 200, a light source unit 420 including a plurality of light-emitting elements, a light source driving unit 430 for driving the light source unit 420, a power supply unit 440 for supplying power to the light source driving unit 430, and a third control unit 450 for controlling the light source driving unit 430 according to a control message received from an external device.

The third communication unit 410 functions the same as the first communication unit 210 illustrated in FIG. 2 and thus a detailed description thereof will not be provided here. The light source unit 420 may include at least one of a red light-emitting element for emitting red light, a green light-emitting element for emitting green light, and a blue light-emitting element for emitting blue light. Also, the light source unit 420 may further include a plurality of white light-emitting elements for emitting white light having different color temperatures. In the light source unit 420, the number of light-emitting elements or a ratio between red, green, blue, and white light-emitting elements may vary according to, for example, the sizes of spaces where the light-emitting elements are installed, or the usage of the light-emitting elements.

The light source driving unit 430 drives the light source unit 420 by varying the amounts of current supplied to the red, green, blue, and white light-emitting elements of the light source unit 420, according to the light properties.

From among the light properties, brightness may be determined according to the amounts of current supplied to the light-emitting elements. For example, if the amounts of current supplied to the light-emitting elements are large, the brightness is increased.

From among the light properties, color may be determined according to a ratio of the currents supplied to the light-emitting elements. For example, in order to realize red light, the light source driving unit 430 may supply a current only to the red light-emitting element, and may not supply currents to the green, blue, and white light-emitting elements. Furthermore, the light source driving unit 430 may adjust color temperature by using a ratio of the currents supplied to the white light-emitting elements.

Although three primary colors of light are red, green, and blue, in the current embodiment, colors obtained by mixing the three primary colors may also be regarded as color as a light property. For example, colors of light may include red, orange, green, blue, white, and the like, and a user may conveniently change the color of light.

Also, the lighting apparatus 400 may further include a third storage 460 in which light source driving information of the light source driving unit 430 matches information regarding a lighting state as a database.

The third control unit 450 controls the other elements of the lighting apparatus 400. The third control unit 450 loads a light source driving information from the third storage 460 according to a control message and controls the light source driving unit 430 according to the light source driving information. For example, if a control message for switching a first light mode into a second light mode is received, the third control unit 450 loads a light source driving information corresponding to the second light mode from the third storage 460 and controls the light source driving unit 430 according to the light source driving information.

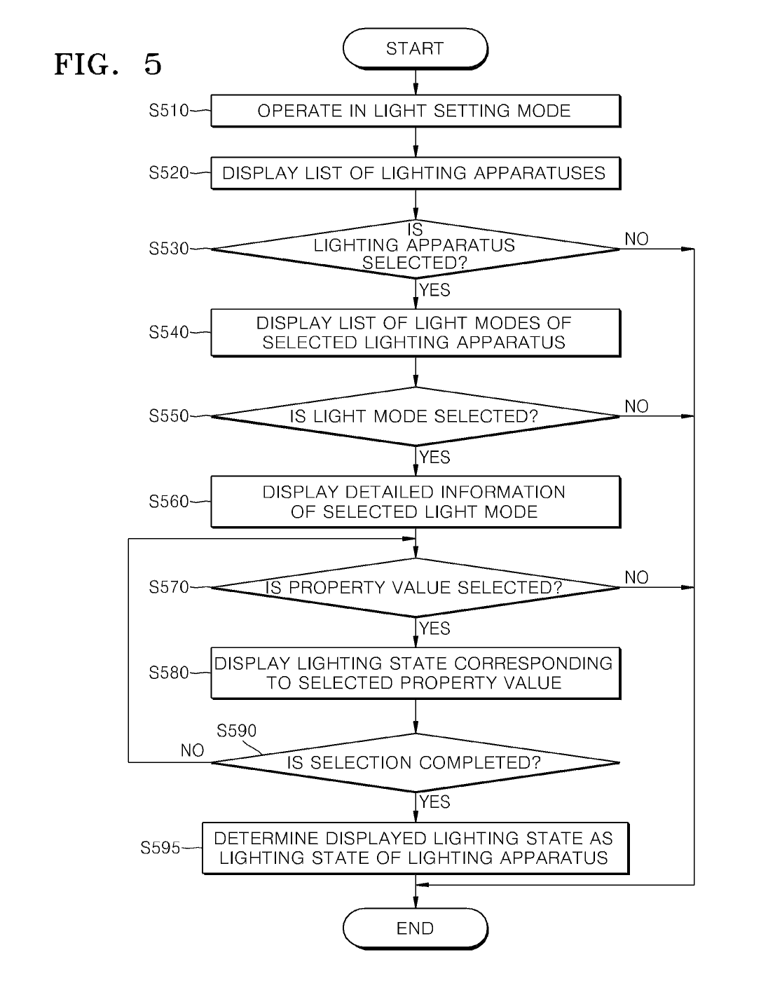

FIG. 5 is a flowchart of a method of setting a lighting state of the lighting apparatus 400 by using the control apparatus 200, according to an embodiment of the present invention. Referring to FIG. 1, the relay apparatus 300 may be already connected to the lighting apparatus 400 and the control apparatus 200. For example, the lighting apparatus 400 searches for the relay apparatus 300 and, if the relay apparatus 300 is found, the lighting apparatus 400 requests the relay apparatus 300 for a connection to the relay apparatus 300. The relay apparatus 300 allocates, for example, an IP address to the lighting apparatus 400, and stores information regarding the lighting apparatus 400, thereby connecting the relay apparatus 300 and the lighting apparatus 400. Also, the control apparatus 200 searches for the relay apparatus 300 according to a user command and, if the relay apparatus 300 is found, the first control unit 240 of the control apparatus 200 generates a message for requesting for a connection to the relay apparatus 300 and transmits the message together with information regarding the control apparatus 200 to the relay apparatus 300. The relay apparatus 300 allocates, for example, an IP address to the control apparatus 200, and generates and transmits a connection response message including the allocated IP address to the control apparatus 200, and thus, the control apparatus 200 may communicate with the relay apparatus 300.

Referring to FIG. 5, the first control unit 240 of the control apparatus 200 operates in a light setting mode for setting a lighting state of the lighting apparatus 400 according to a user command (S510).

In the light setting mode, the first control unit 240 of the control apparatus 200 generates an apparatus request message for requesting for information regarding the lighting apparatuses 400 connected to the relay apparatus 300, and the first communication unit 210 of the control apparatus 200 transmits the apparatus request message to the relay apparatus 300. The second control unit 320 of the relay apparatus 300 loads the information regarding the connected lighting apparatuses 400 from the second storage 330. The second control unit 320 generates an apparatus response message including the information regarding the connected lighting apparatuses 400 and transmits the apparatus response message to the second communication unit 310. The second communication unit 310 transmits the apparatus response message to the control apparatus 200. In addition, the apparatus response message may further include information regarding spaces where the lighting apparatuses 400 exist.

The first control unit 240 may generate and display a list of the lighting apparatuses 400 on the display unit 220 (S520). The list of the lighting apparatuses 400 may be displayed as the information regarding the lighting apparatuses 400 or information regarding the spaces where the lighting apparatuses 400 exist.

If a user command for selecting a certain lighting apparatus 400 from among the list of the lighting apparatuses 400 is input (S530-Y), the first control unit 240 loads information regarding light modes of the selected lighting apparatus 400 from the first storage 250, generates a list of the light modes by using the information regarding the light modes, and displays the list of the light modes on the display unit 220 (S540). If the information regarding the light modes of the selected lighting apparatus 400 does not exist in the first storage 250, the first control unit 240 may generate and transmit a message for requesting for the information regarding the light modes to the lighting apparatus 400 via the relay apparatus 300. If the information regarding the light modes is received from the lighting apparatus 400 as a response, the list of the light modes may be displayed. The light modes may include a user mode, a scene mode, and a power mode.

If a user command for selecting a certain light mode from among the list of the light modes is input (S550-Y), the first control unit 240 displays detailed information of the selected light mode on the display unit 220 (S560). The detailed information of the user mode may include information regarding light properties, information regarding property values of the light properties, and property changing indicators for changing the light properties. A method of setting the lighting state in the user mode is described below. The detailed information of the scene mode may include a relax mode, a study mode, and a sleep mode.

If a user command for selecting a property value of the light property by using the detailed information of the light mode is input (S570-Y), the first control unit 240 displays a lighting state corresponding to the selected property value on the display unit 220 (S580).

Then, if it is determined that the property value is completely selected (S590-Y), the first control unit 240 determines the lighting state displayed on the display unit 220 as a lighting state to be executed by the lighting apparatus 400. After that, the first control unit 240 may store information regarding the lighting state displayed according to the user command in the first storage 250, or may include the information regarding the lighting state into a message for requesting to execute the lighting state (hereinafter referred to as ‘an execution request message’) and transmit the execution request message to the lighting apparatus 400. If a user inputs a command for requesting to execute the displayed lighting state, the first control unit 240 generates and transmits the execution request message to the lighting apparatus 400. However, if a command for requesting to execute the lighting state when a certain condition is satisfied is input, the first control unit 240 stores the information regarding the lighting state in the first storage 250 and, if the certain condition is satisfied, generates and transmits an execution request message including the information regarding the lighting state stored in the first storage 250, to the lighting apparatus 400.

If the execution request message is received, the third control unit 450 of the lighting apparatus 400 loads a light source driving information corresponding to the selected property value from the third storage 460 and controls the light source driving unit 430 according to the light source driving information, the light source driving unit 430 drives the light source unit 420 by using power supplied from the power supply unit 440 based on the light source driving information, and thus, the light source unit 420 emits light as a user desires.

The control apparatus 200 sets a lighting state of the lighting apparatus 400 via the relay apparatus 300 in the above descriptions, the control apparatus 200 is not limited thereto. The control apparatus 200 may sets the lighting state of the lighting apparatus 400 without using the relay apparatus 300.

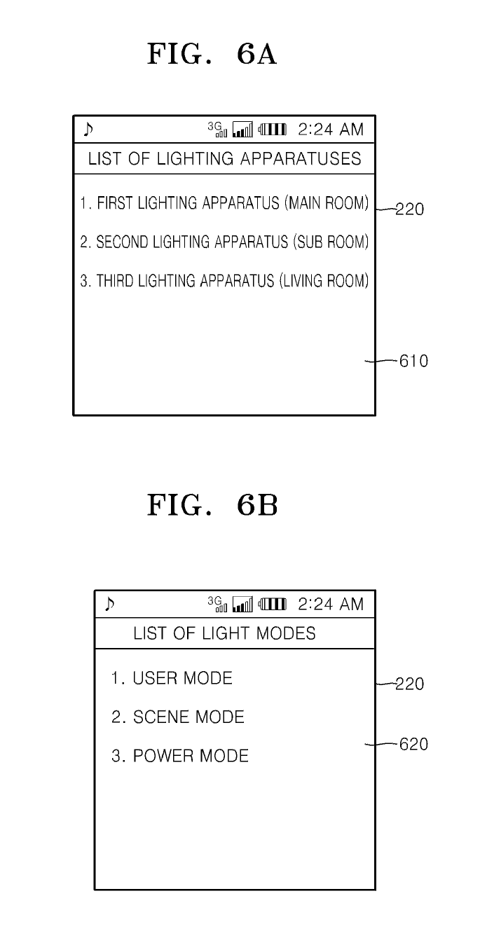

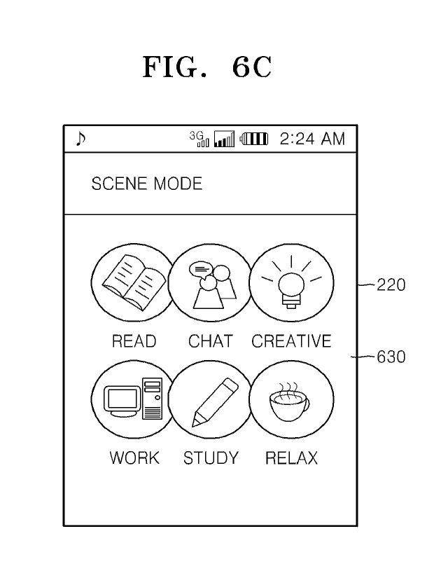

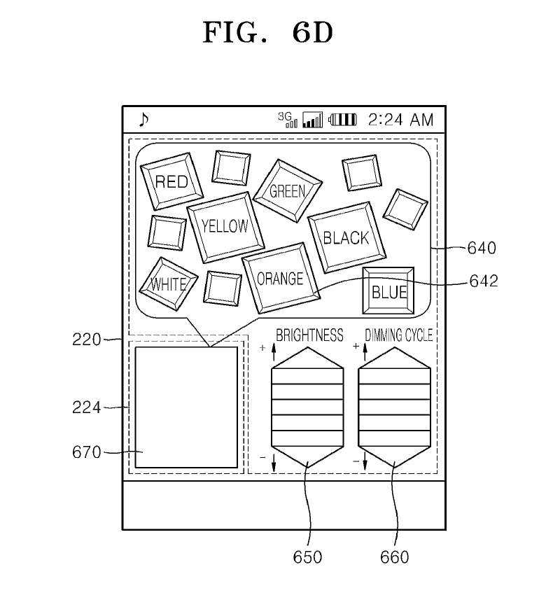

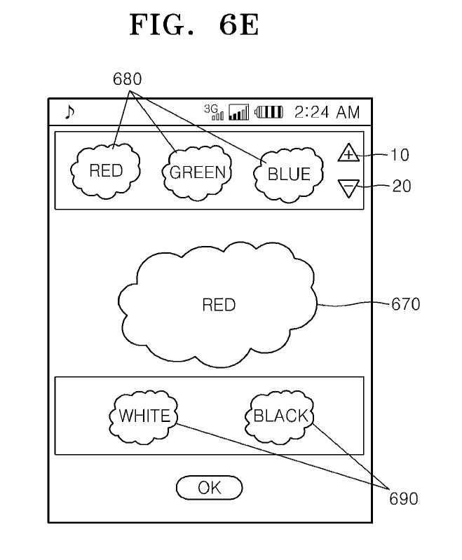

FIGS. 6A through 6E are images of a user interface for setting a lighting state, according to an embodiment of the present invention.

If the control apparatus 200 operates in a light setting mode, as illustrated in FIG. 6A, the first control unit 240 may display a list 610 of the lighting apparatuses 400 for which light can be set. If the control apparatus 200 is a mobile device, the control apparatus 200 may include, e.g., a phone-calling function as well as a function of setting lighting of the lighting apparatuses 400. In this case, a user command for changing the mode of the control apparatus 200 into the light setting mode for setting a lighting state of the lighting apparatus 400 may be input. The first control unit 240 obtains information regarding lighting apparatuses 400 that the first control unit 240 is communicable with. For example, if the control apparatus 200 is directly communicable with the lighting apparatuses 400 without using the relay apparatus 300, the control apparatus 200 may directly obtain the information regarding the lighting apparatuses 400. Otherwise, if the control apparatus 200 is communicable with the lighting apparatuses 400 via the relay apparatus 300, the control apparatus 200 requests the relay apparatus 300 for the information regarding the lighting apparatuses 400, and the relay apparatus 300 obtains and transmits the information regarding the lighting apparatuses 400 to the control apparatus 200. The first control unit 240 generates and displays the list 610 of the lighting apparatuses 400 on the display unit 220. The list 610 of the lighting apparatuses 400 may be displayed as information regarding spaces where the lighting apparatuses 400 are installed, as well as the information regarding the lighting apparatuses 400.

A user command for selecting a certain lighting apparatus 400 from the list 610 of the lighting apparatuses 400 may be input. Then, as illustrated in FIG. 6B, the first control unit 240 may display a list 620 of light modes of the selected lighting apparatus 400. The list 620 of the light modes may include at least one of a user mode in which a user directly selects property values of light properties to set a lighting state, a scene mode in which property values of light properties are pre-determined for every scene and a lighting state is set by selecting a scene, and a power mode for powering on or off the lighting apparatus 400.

Also, if only one lighting apparatus 400 is connected in a network, the first control unit 240 may directly display the list 620 of the light modes without displaying the list 610 of the lighting apparatuses 400.

If a user command for selecting the scene mode is input, as illustrated in FIG. 6C, the first control unit 240 may display detailed information 630 of the scene mode. A user command for setting a lighting state may be input by selecting one of the detailed information 630. Although the detailed information 630 of the scene mode is displayed if the scene mode is selected in FIG. 6C, the current embodiment is not limited thereto. The detailed information 630 of the scene mode may be displayed together with the user mode and the power mode.

If a user command for selecting the user mode is input, as illustrated in FIG. 6D, the first control unit 240 displays first through third light properties 640, 650, and 660, and a predetermined lighting state 670. Each light property, e.g., the first light property 640, may be displayed as a list or icon of property values 642 representing the first light property 640. In FIG. 6D, the first light property 640 is displayed as a list of the property values 642, and the first through third light properties 640, 650, and 660 include color and brightness. The predetermined lighting state 670 may display a current lighting state of the lighting apparatus 400 or a lighting state selected in a previous user mode. If the user selects a property value, a lighting state corresponding to the selected property value may be displayed.

Alternatively, if a user command for selecting the user mode is input, the first control unit 240 may display light properties as icons. For example, as illustrated in FIG. 6E, the first control unit 240 may display on the display unit 220 the light properties as color icons 680 for selecting a color and brightness icons 690 for selecting a brightness level, and may display an addition icon 10 for adding a color or a brightness level, and a subtraction icon 20 for subtracting a color or a brightness level. Also, the first control unit 240 may display the lighting state 670.

In FIG. 6D, selectable property values are already displayed and the user may set a lighting state by selecting one of the displayed property values. However, in FIG. 6E, basic property values individually representing light properties are displayed and the user may set a lighting state by selecting a combination of the basic property values. A method of selecting a lighting state in a user mode will now be described in detail.

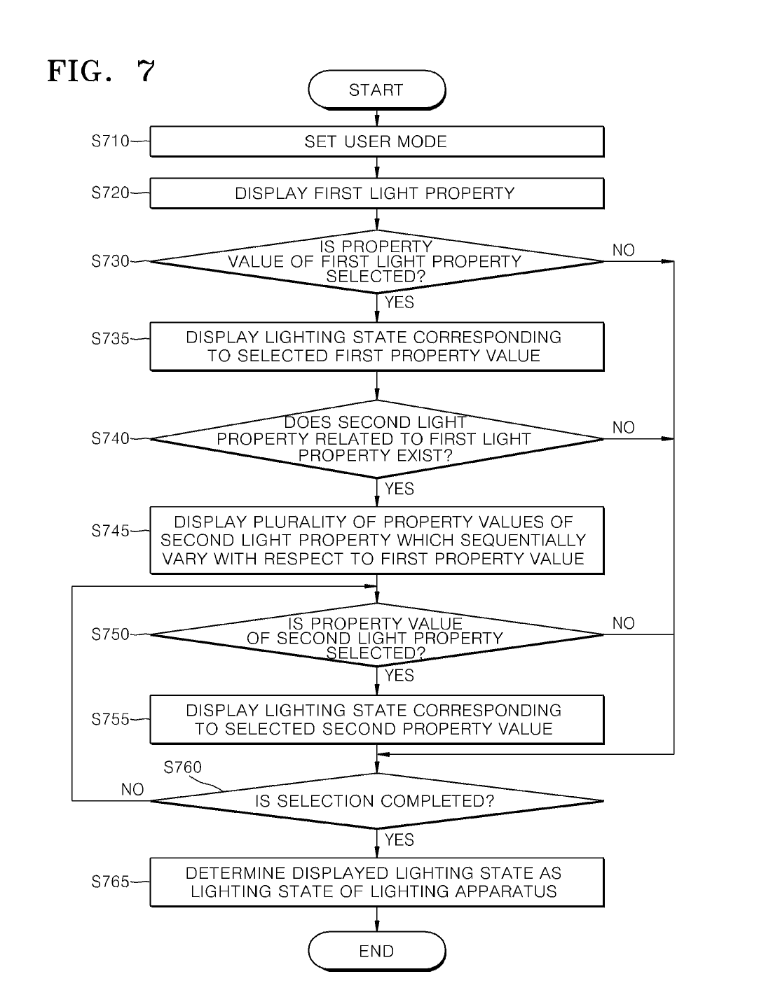

FIG. 7 is a flowchart of a method of setting a lighting state of the lighting apparatus 400 in a user mode, according to an embodiment of the present invention.

Referring to FIG. 7, if the user mode is set from among light modes (S710), the first control unit 240 loads from the first storage 250 a first light property for determining the lighting state of the lighting apparatus 400 and displays the first light property on the display unit 220 (S720). Light properties may include color, brightness, color temperature, and dimming cycle of light emitted from the lighting apparatus 400. The first control unit 240 may display one of the light properties, e.g., color, brightness, color temperature, and dimming cycle, as the first light property. Each light property may be displayed as a plurality of property values representing detailed information of the light property. For example, if the first light property is color, various colors may be displayed as the property values.

When the first light property of the lighting apparatus 400 is displayed, the first control unit 240 may also display a current lighting state of the lighting apparatus 400. In order to display the current lighting state, the first control unit 240 transmits a state request message for requesting for information regarding the current lighting state of the lighting apparatus 400. Then, the third control unit 450 of the lighting apparatus 400 loads from the third storage 460 a property value corresponding to current light source driving information of the light source driving unit 430. The third control unit 450 generates and transmits a state response message including the above property value, i.e., the information regarding the current lighting state, to the control apparatus 200 via the third communication unit 410, and thus the control apparatus 200 may obtain the information regarding the current lighting state.

The first control unit 240 determines whether a user command for selecting a property value of the first light property is input (S730). A user command for selecting at least one property value displayed on the display unit 220 may be input. If the user command for selecting a property value is input (S730-Y), the first control unit 240 displays a lighting state corresponding to the selected property value of the first light property (hereinafter referred to as ‘a first property value’) on the display unit 220 (S735).

The first control unit 240 determines whether a second light property related to the first light property exists (S740). If it is determined that the second light property related to the first light property exists (S740-Y), the first control unit 240 may display on the display unit 220 a plurality of property values of the second light property which sequentially vary with respect to a selected property value (S745). For example, color and brightness are related light properties. Thus, a user command for selecting a certain color corresponding to a first property value of color corresponding to the first light property may be input. Then, in order to display property values of brightness corresponding to the second light property, the first control unit 240 may display a plurality of property values corresponding to brightness levels which sequentially vary with respect to the selected first property value.

If a user command for selecting a property value of the second light property is input (750-Y), the first control unit 240 may display a lighting state corresponding to the selected property value of the second light property (hereinafter referred to as ‘a second property value’) on the display unit 220 (S755). After that, a user command representing that selection is completed is input (S760-Y), the first control unit 240 ultimately determines the displayed lighting state as the lighting state of the lighting apparatus 400 (S765).

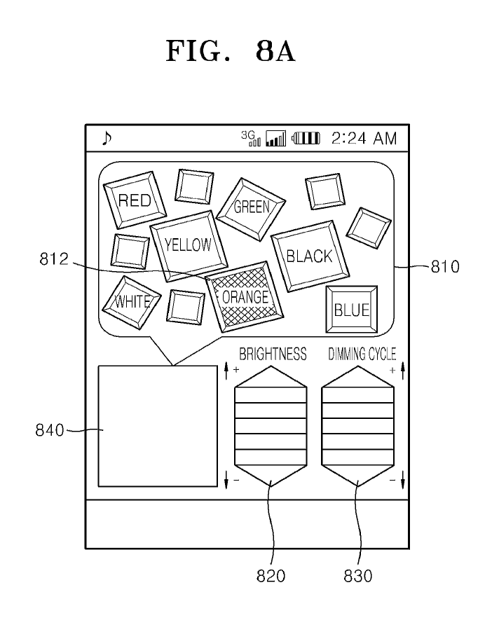

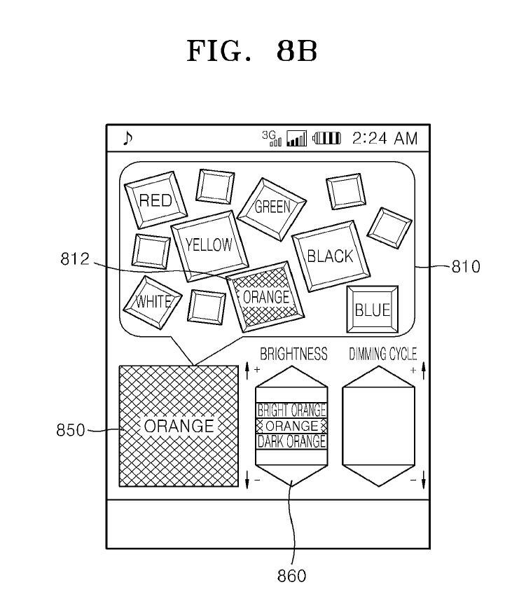

FIGS. 8A and 8B are images of a user interface for setting a lighting state in a user mode, according to an embodiment of the present invention.

If a user command for selecting the user mode is input, as illustrated in FIG. 8A, the first control unit 240 displays on the display unit 220 a list of first through third light properties 810, 820, and 830 with their property values, and a current lighting state 840. If a user command for selecting a property value is input, the first control unit 240 may display a lighting state corresponding to the selected property value instead of the current lighting state 840.

For example, if a user selects a first property value 812 from among property values of the first light property 810 corresponding to color, as illustrated in FIG. 8B, the first control unit 240 displays a lighting state 850 corresponding to the selected first property value 812 on a state display region. The first control unit 240 may display a second light property 860 corresponding to brightness related to color, as a plurality of property values corresponding to brightness levels which sequentially vary with respect to the selected first property value 812. However, since a dimming cycle is not related to color, a previous dimming cycle may be displayed. Although a plurality of light properties are simultaneously displayed on one screen in FIGS. 8A and 8B, the current embodiment is not limited thereto. The light properties may be sequentially displayed on the display unit 220 one by one. For example, after a first light property is displayed, if a property value of the first light property is selected, a second light property related to the first light property may be displayed. If a property value of the second light property is selected, another light property may be displayed.

As described above, since color and brightness are related to each other, by displaying only property values corresponding to highly selectable brightness levels, information regarding light properties may be efficiently displayed on a small display unit.

In addition, if a property value of a certain light property is selected, since property values of another light property related to the selected property value are displayed, a lighting state may be set more precisely.

Although related light properties may be displayed in connection with each other, a lighting state may be set by using property values of the light properties as independent components.

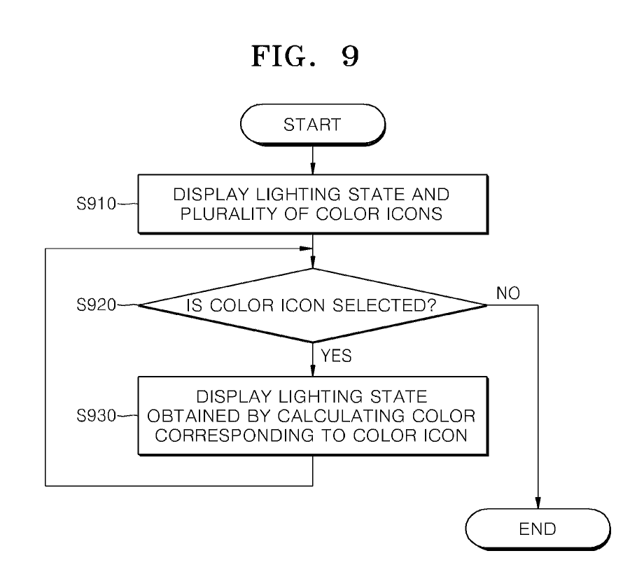

FIG. 9 is a flowchart of a method of changing the color of a lighting state, according to an embodiment of the present invention.

If a user mode is set from among light modes, the first control unit 240 displays on the display unit 220 a lighting state and a plurality of color icons for controlling the color of the lighting state (S910). The lighting state already displayed on the display unit 220 is an arbitrary lighting state, e.g., a lighting state set in a previous user mode or a current lighting state of the lighting apparatus 400. The color icons are icons displayed as colors, and may include a red icon representing red, a blue icon representing blue, and a green icon representing green. The color icons may be displayed as basic colors but are not limited thereto and may be displayed as mixed colors. In addition, the display unit 220 may additionally display an addition icon for adding a color and a subtraction icon for subtracting a color.

The first control unit 240 determines whether a user command for selecting a color icon is input (S920). If the display unit 220 is realized as a touch screen, the user command for selecting a color icon may be input by touching a region where the color icon is displayed on the display unit 220, and then touching a region where the addition icon or the subtraction icon is displayed. Then, the first control unit 240 determines that the user command for selecting a color icon is input.

If the user command for selecting a color icon is input (S920-Y), the first control unit 240 displays a color-changed lighting state by calculating a color corresponding to the selected color icon onto the already-displayed lighting state (S930). For example, if a user command is input by touching the red icon and the addition icon, the first control unit 240 adds the selected red to the already-displayed lighting state and displays a more reddish lighting state. If a user command is input by touching the red icon and the subtraction icon, the first control unit 240 subtracts red from the already-displayed lighting state and displays a less reddish lighting state.

If a user command representing that selection is completed is input, the first control unit 240 generates information regarding a lighting state corresponding to the selected property values. As described above, if the color icons are used, a user-selected color may be more dynamically reflected to a lighting state.

Although the color of a lighting state is changed in FIG. 9, the present invention is not limited thereto and the brightness of a lighting state may also be changed.

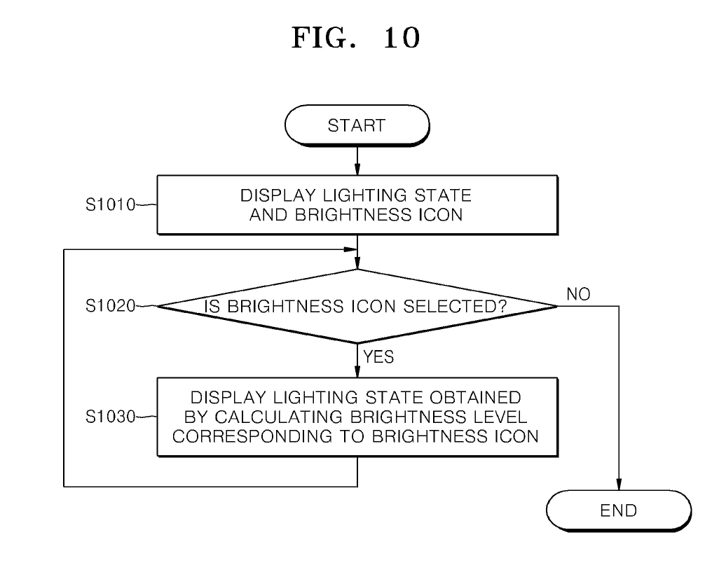

FIG. 10 is a flowchart of a method of changing the brightness of a lighting state, according to an embodiment of the present invention.

If a user mode is set from among light modes, the first control unit 240 may display on the display unit 220 a lighting state and at least one brightness icon for controlling the brightness of the lighting state (S1010). The lighting state already displayed on the display unit 220 is an arbitrary lighting state, e.g., a lighting state set in a previous user mode or a current lighting state of the lighting apparatus 400. The brightness icon may include at least one of a black icon representing no brightness and a white icon representing full brightness. Alternatively, the brightness icon may include a gray icon in which black and white are mixed. In addition, an addition icon for adding a brightness level and a subtraction icon for subtracting a brightness level may be additionally displayed.

The first control unit 240 determines whether a user command for selecting a brightness icon is input (S1020). If the display unit 220 is realized as a touch screen, the user command for selecting the brightness icon may be input by touching a region where the brightness icon is displayed on the display unit 220. For example, a user command may be input by touching the white icon. Then, the first control unit 240 determines that a user command for increasing the brightness is input. Likewise, a user command may be input by touching the black icon. Then, the first control unit 240 determines that a user command for reducing the brightness is input.

If the user command for selecting the brightness icon is input (S1020-Y), the first control unit 240 displays a brightness-changed lighting state by calculating a brightness level corresponding to the selected brightness icon onto the already-displayed lighting state (S1030). For example, if a user command for increasing the brightness is input, the first control unit 240 displays a brighter lighting state. If a user command for reducing the brightness is input, the first control unit 240 displays a darker lighting state.

If a user command representing that selection is completed is input, the first control unit 240 generates information regarding a lighting state corresponding to the selected property value. As described above, if the brightness icon is used, a user may freely control the brightness of a lighting state.

Although the brightness of a lighting state is changed in FIG. 9, the present invention is not limited thereto and the brightness of a lighting state may also be changed.

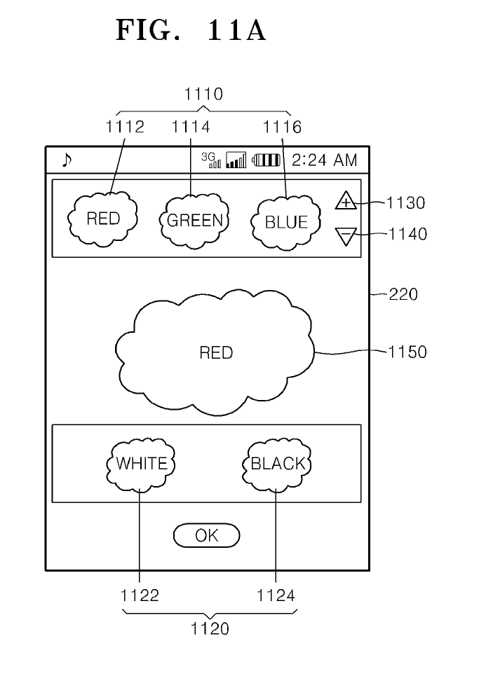

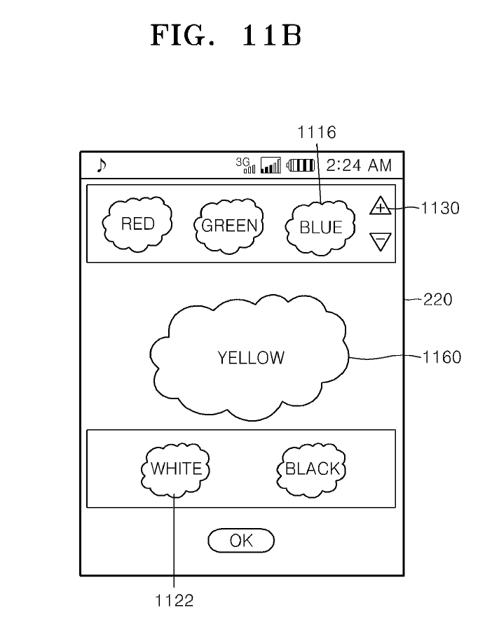

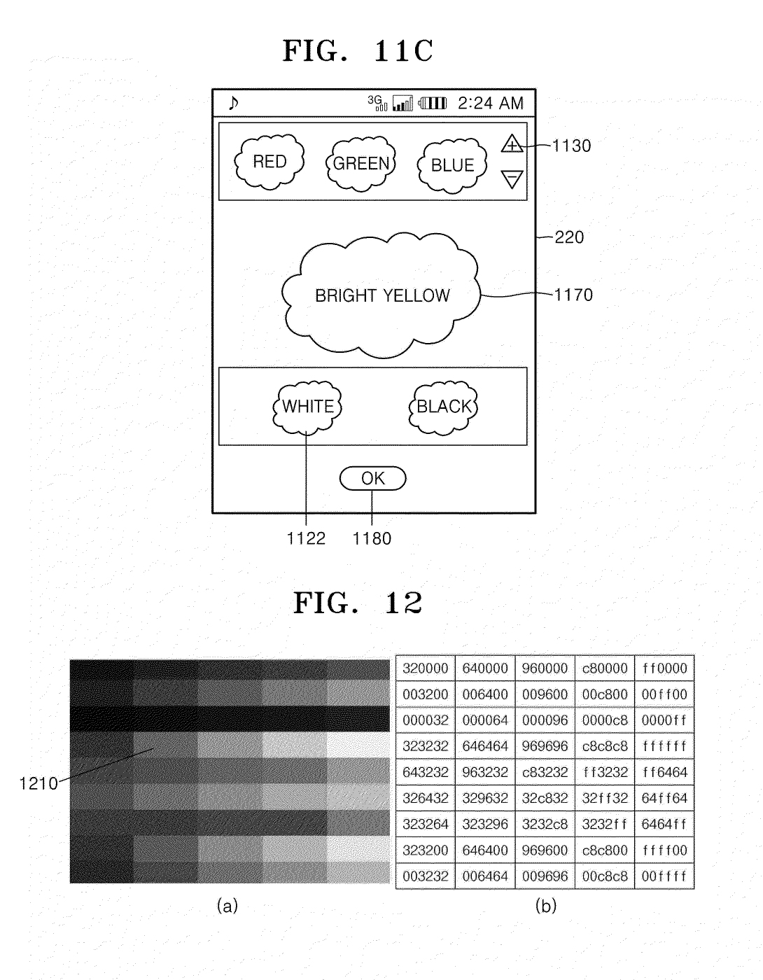

FIGS. 11A through 11C are images of a user interface for setting a lighting state in a user mode, according to another embodiment of the present invention.

If a user command for selecting the user mode is input, as illustrated in FIG. 11A, the first control unit 240 may display on the display unit 220 a plurality of color icons 1110 for selecting a color, brightness icons 1120 for selecting a brightness level, an addition icon 1130 for adding a color, and a subtraction icon 1140 for subtracting a color. If a user command for selecting a color is input, the first control unit 240 may display a second lighting state 1160 obtained by calculating the color onto an already-displayed first lighting state 1150.

For example, when the first lighting state 1150 corresponding to red is displayed, if a user command for selecting a blue icon 1116 and the addition icon 1130 is input, the first control unit 240 may determine and display the second lighting state 1160 corresponding to yellow by calculating blue onto the first lighting state 1150.

If a user command for controlling a brightness level is input, the first control unit 240 may display a third lighting state 1170 obtained by calculating the brightness level onto the second lighting state 1160. For example, when the second lighting state 1160 corresponding to yellow is displayed, if a user command for selecting a white icon 1122 is input, the first control unit 240 may generate and display the third lighting state 1170 corresponding to bright yellow by calculating white onto the second lighting state 1160.

If a user desires to set the third lighting state 1170 as the lighting state of the lighting apparatus 400 and thus selects an OK icon 1180, the first control unit 240 determines the third lighting state 1170 as the lighting state of the lighting apparatus 400.

Meanwhile, in order to display a color-changed or brightness-changed lighting state, the first control unit 240 may use a lighting code corresponding to the lighting state. The lighting code is a code representing the lighting state, and may be a hexadecimal (HEX) code. The lighting code may include sub code regions corresponding to the color icons. For example, the lighting code may include three sub code regions. The three sub code regions may include a red code region representing red, a green code region representing green, and a blue code region representing blue. Whenever a color icon is selected, the first control unit 240 calculates a unit color code onto a sub code region corresponding to the selected color icon. And, whenever a brightness code is selected, the first control unit 240 calculates a unit brightness code onto each of all sub code regions. Here, the unit color code is defined as a minimum value of differences in color codes in sub code regions having different colors in two lighting states having the same brightness level but different colors, and the unit brightness code is defined as a minimum value of differences in brightness codes in sub code regions having different brightness levels in two lighting states having the same color but different brightness levels. Also, the unit color code and the unit brightness code used to generate lighting codes corresponding to lighting states may be previously defined.

FIGS. 12A and 12B are an image and a table, respectively, showing correlations between lighting states and lighting codes, according to an embodiment of the present invention. FIG. 12A shows lighting states and FIG. 12B shows lighting codes corresponding to the lighting states.

In FIGS. 12A and 12B, a lighting code may include six code regions. From among the six code regions, every two neighboring code regions are grouped into one sub code region. From the left, the first and second code regions may be allocated as a first sub code region representing red, the third and fourth code regions may be allocated as a second sub code region representing green, and the fifth and sixth code regions may be allocated as a third sub code region representing blue. Each sub code region may include a code representing a basic color. Also, as shown in FIG. 12B, a unit color code and a unit brightness code of lighting codes are 32. Thus, whenever a certain color is added, the first control unit 240 may add a unit color code to a corresponding sub code region. For example, if a code of a red code region is 00, whenever a red icon is added, the first control unit 240 may add the unit color code, i.e., 32, to the red code region to generate red codes of 32, 64, 96, c8, and ff. The unit color code and the unit brightness code are variable. For example, in order to represent a large number of lighting states, the unit color code and the unit brightness code may be small.

A database in which the lighting states and the lighting codes are matched may be stored in the first storage 250. Thus, when a certain lighting state is displayed in a user mode, the first control unit 240 loads a lighting code corresponding to the lighting state from the first storage 250. Whenever a color icon is selected, the first control unit 240 generates a new lighting code by calculating a unit color code onto a sub code region corresponding to the selected color icon. The first control unit 240 may load a lighting state corresponding to the new lighting code from the first storage 250 and may display the lighting state on the display unit 220. The same principal applies to a brightness icon. That is, whenever a brightness icon is selected, the first control unit 240 generates a new lighting code by calculating a unit brightness code onto each of the three sub code regions. The first control unit 240 may load a lighting state corresponding to the new lighting code from the first storage 250 and may display the lighting state on the display unit 220.

For example, when a lighting code of an already-displayed lighting state is 323232, a user command for adding a brightness level may be input. The first control unit 240 generates a lighting code of 646464 by adding a unit brightness code, i.e., 32, to all sub code regions. The first control unit 240 may load a lighting state 1210 corresponding to 646464 from the first storage 250 and may display the lighting state 1210 on the display unit 220.

In order to allow the above lighting state to be executed by in the lighting apparatus 400, a user command for requesting to execute the lighting state may be input. Then, the first control unit 240 generates and transmits an execution request message including information regarding the lighting state to the lighting apparatus 400. The lighting apparatus 400 sets the lighting state according to the execution request message. The control apparatus 200 may transmit the execution request message to the lighting apparatus 400 directly or via the relay apparatus 300.

If the control apparatus 200 is a mobile device, a user carries the control apparatus 200. If the control apparatus 200 enters a region communicable with the lighting apparatus 400, the lighting apparatus 400 may automatically execute the lighting state set by the user. The execution of the lighting state according to the location of the control apparatus 200 is advantageous when the control apparatus 200, the relay apparatus 300, and the lighting apparatus 400 perform short-distance communication. Thus, the relay apparatus 300 may be an AP that performs short-distance communication with the control apparatus 200 and the lighting apparatus 400.

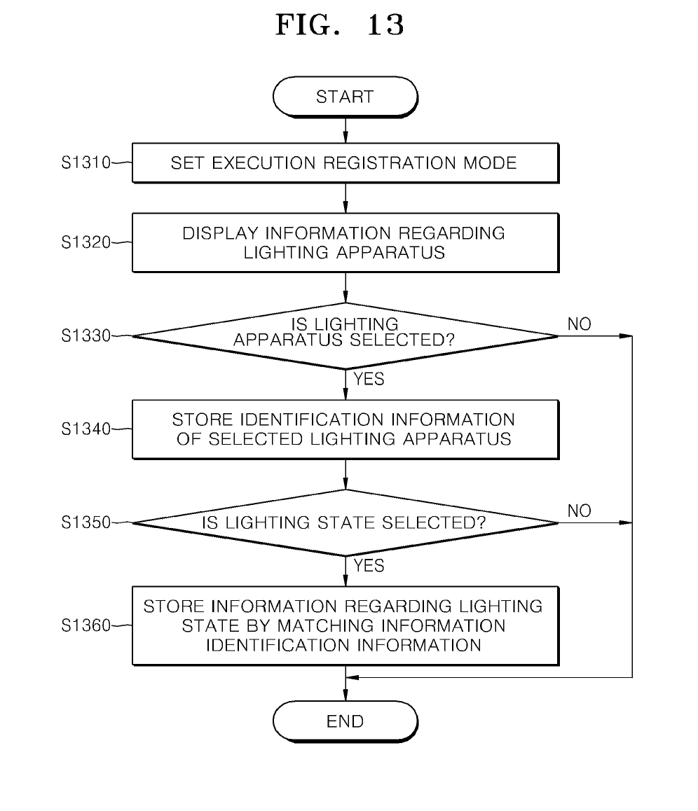

FIG. 13 is a flowchart of a method of registering the lighting apparatus 400 to automatically execute a lighting state, according to an embodiment of the present invention.

According to a user command, the first control unit 240 sets an execution registration mode for registering a lighting state and the lighting apparatus 400 for automatically executing the lighting state (S1310).

If the execution registration mode is set, the first control unit 240 obtains information regarding the lighting apparatus 400 communicable with the relay apparatus 300, and displays the obtained information regarding the lighting apparatus 400 on the display unit 220 (S1320). For example, the control apparatus 200 transmits to the relay apparatus 300 an inquiry message for asking whether the lighting apparatus 400 is communicable. The relay apparatus 300 transmits to the control apparatus 200 a response message representing that the lighting apparatus 400 is communicable. The response message may include the information regarding the lighting apparatus 400. Alternatively, the control apparatus 200 may directly transmit to the lighting apparatus 400 an inquiry message for asking whether the lighting apparatus 400 is communicable, and may directly receive from the lighting apparatus 400 a response message representing that the lighting apparatus 400 is communicable. The information regarding the lighting apparatus 400 may include, for example, a static IP address, space information, and a product name of the lighting apparatus 400.

If a plurality of lighting apparatuses 400 are communicable, the first control unit 240 displays a list of the lighting apparatuses 400 on the display unit 220. The list of the lighting apparatuses 400 may include information regarding the lighting apparatuses 400. For example, the list of the lighting apparatuses 400 may be displayed as space information of the lighting apparatuses 400.

If a user command for selecting the lighting apparatus 400 is input (S1330-Y), the first control unit 240 stores identification information of the lighting apparatus 400 (S1340). If the control apparatus 200 directly communicates with the lighting apparatus 400, the first control unit 240 may store, for example, a private IP address of the lighting apparatus 400 as the identification information of the lighting apparatus 400. If the control apparatus 200 communicates with the lighting apparatus 400 via the relay apparatus 300, the first control unit 240 may store identification information of the relay apparatus 300 and the lighting apparatus 400. Here, the identification information of the relay apparatus 300 may be a static IP address of the relay apparatus 300. Also, if the control apparatus 200 communicates with the lighting apparatus 400 by using port forwarding of the relay apparatus 300, the first control unit 240 may store identification information and port information of the relay apparatus 300 as the identification information of the lighting apparatus 400.

If a user command for selecting a lighting state is input (S1350-Y), the first control unit 240 determines the selected lighting state as a lighting state to be executed by the lighting apparatus 400, and stores information regarding the lighting state by matching the information to the information regarding the lighting apparatus 400 (S1360). A method of setting the lighting state is described above.

Meanwhile, if the relay apparatus 300 performs port forwarding, the identification information of the lighting apparatus 400 may be replaced by the identification information and the port information of the relay apparatus 300 for forwarding a port to the lighting apparatus 400. The port information may be previously set by, for example, a user. The identification information of the relay apparatus 300 may be a static IP address of the relay apparatus 300 or a virtual static IP address corresponding to a current IP address of the relay apparatus 300. The current IP address is a public IP address of the relay apparatus 300 and may be a dynamic IP address. Thus, the virtual static IP address may be used to allow the dynamic IP address to be static and the virtual static IP address may be domain information. A website for matching and managing the dynamic IP address and the domain information of the relay apparatus 300 (hereinafter referred to as ‘a virtual IP management site’) may be used. Whenever the dynamic IP address of the relay apparatus 300 is updated, the virtual IP management site stores the updated dynamic IP address by matching the updated dynamic IP address to the domain information. The virtual IP management site may be a dynamic domain name server (DDNS). If the identification information and the port information of the relay apparatus 300 are set as described above, the control apparatus 200 may control light of the lighting apparatus 400 by using port forwarding of the relay apparatus 300.

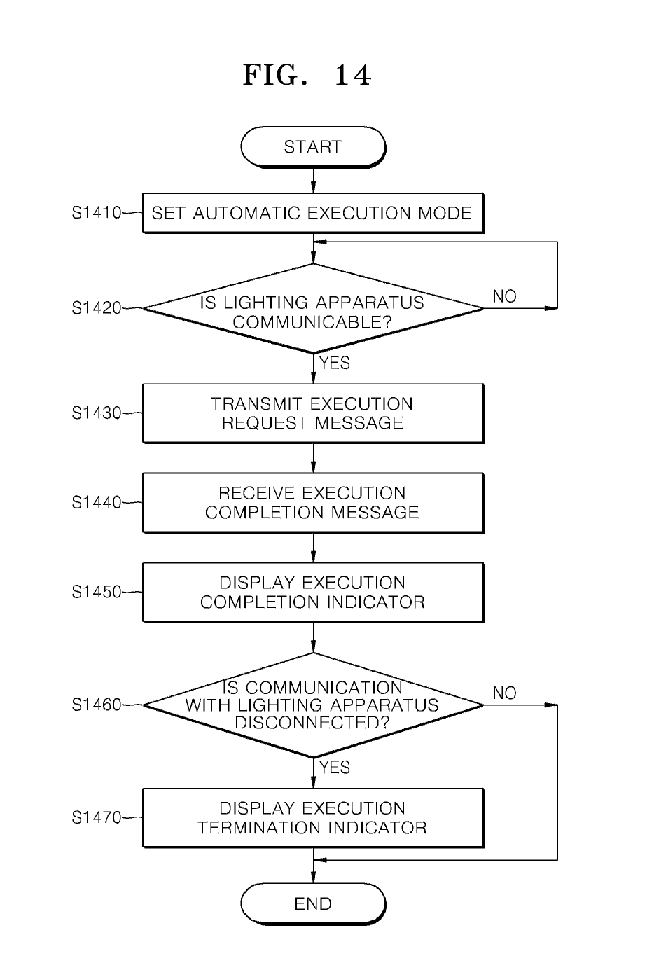

FIG. 14 is a flowchart of a method of requesting to execute a lighting state by the control apparatus 200, according to an embodiment of the present invention.

The control apparatus 200 is set in an automatic execution mode according to a user command (S1410).

The first control unit 240 determines whether the lighting apparatus 400 is communicable (S1420). If a user having the control apparatus 200 enters a region communicable with the lighting apparatus 400, the first control unit 240 determines that the lighting apparatus 400 is communicable. For example, if identification information of the lighting apparatus 400 is stored, the first control unit 240 searches for the lighting apparatus 400 at regular time intervals and determines that the lighting apparatus 400 is communicable if the lighting apparatus 400 is found. Alternatively, if identification information of the lighting apparatus 400 and the relay apparatus 300 is stored or if identification information and port information of the relay apparatus 300 are stored, the first control unit 240 searches for the relay apparatus 300 and determines that the lighting apparatus 400 is communicable if the relay apparatus 300 is found. If the identification information of the relay apparatus 300 is domain information, the control apparatus 200 asks a virtual IP management site for a dynamic IP address corresponding to the domain information, and searches for the relay apparatus 300 by using the dynamic IP address if the dynamic IP address is obtained from the virtual IP management site.

If it is determined that the lighting apparatus 400 is communicable (S1420-Y), the first control unit 240 reads information regarding a lighting state, which is stored and matched to the lighting apparatus 400. The first control unit 240 generates an execution request message including the read information regarding the lighting state, and transmits the execution request message to the lighting apparatus 400 (S1430). The lighting apparatus 400 generates an execution completion message representing that the lighting state is completely executed, and transmits the execution completion message to the control apparatus 200.

The control apparatus 200 receives the execution completion message from the lighting apparatus 400 (S1440). The first control unit 240 generates an execution completion indicator representing that the lighting state is executed, and displays the execution completion indicator on the display unit 220 (S1450). Thus, a user may view the execution completion indicator displayed on the control apparatus 200 and may check the lighting state of the lighting apparatus 400.

Meanwhile, if it is determined that the communication with the lighting apparatus 400 is disconnected (S1460-Y), the first control unit 240 generates an execution termination indicator representing that the lighting state executed by the lighting apparatus 400 is terminated, and displays the execution termination indicator on the display unit 220 (S1470). The execution request message may include information regarding an execution period of the lighting state. The lighting apparatus 400 executes the lighting state only in the execution period, and terminates the execution of the lighting state after the execution period. After the execution request message is transmitted to the lighting apparatus 400, the control apparatus 200 retransmits the execution request message within the execution period. The retransmission is repetitive. However, if the control apparatus 200 is out of the communicable region, the control apparatus 200 may not receive the execution completion message from the lighting apparatus 400. The lighting apparatus 400 executes the lighting state during the execution period of the lastly transmitted execution request message, and then terminates the execution of the lighting state. Thus, if a response message to the execution request message is not received, the first control unit 240 determines that the communication with the lighting apparatus 400 is disconnected, and generates and displays the execution termination indicator on the display unit 220.

As such, when the control apparatus 200 is set in the automatic execution mode, if a user enters a region communicable with the lighting apparatus 400, a lighting state of the lighting apparatus 400 is automatically executed as long as the user carries the control apparatus 200. Furthermore, if the user is out of the region communicable with the lighting apparatus 400, the execution of the lighting state is automatically terminated. Thus, the user may conveniently unitize the lighting apparatus 400 by using the control apparatus 200.

The present invention can also be implemented as processor-readable code on a processor-readable recording medium included in a mobile device such as a mobile station modem (MSM). The processor-readable recording medium is any data storage device that can store data which can be thereafter read by a processor. Examples of the processor-readable recording medium include read-only memory (ROM), random-access memory (RAM), CD-ROMs, magnetic tapes, floppy disks, optical data storage devices, etc. The processor-readable recording medium can also be distributed over network-coupled computer systems so that the processor-readable code is stored and executed in a distributed fashion.

In a method, system, and apparatus for controlling light, according to the present invention, a user may change a lighting state of a lighting apparatus without spatial restrictions by controlling light of the lighting apparatus via a network.

Also, since property values of a light property which are highly selectable by a user are displayed on a restricted screen, the user may easily set a lighting state.

Furthermore, since a user may set the color or brightness of a lighting state by selecting a color icon or a brightness icon, the user may instinctively set the lighting state.

In addition, since a lighting state is automatically executed if a control apparatus enters a region communicable with a lighting apparatus, light of the lighting apparatus may be conveniently controlled.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method of controlling light, the method comprising:
displaying on a display unit at least one light property representing a property of the light of a lighting apparatus;
if a user command for selecting a property value of the light property is input, displaying a lighting state corresponding to the selected property value; and
if a user command representing that selection is completed is input, determining the displayed lighting state as a lighting state of the lighting apparatus.

2. The method of claim 1, wherein the light property is information regarding color, brightness, color temperature, or dimming cycle of the light emitted from the lighting apparatus.

3. The method of claim 1, wherein, when the light property is displayed, a current lighting state of the lighting apparatus is also displayed on the display unit.

4. The method of claim 1, wherein the light property is displayed as a plurality of property values corresponding to the light property.

5. The method of claim 1, wherein the light property comprises a first light property and a second light property, and
wherein the method further comprise, if a user command for selecting a first property value of the first light property is input, displaying a plurality of property values of the second light property related to the first property value.

6. The method of claim 5, wherein the first light property is color, and the second light property is brightness.

7. The method of claim 5, wherein the plurality of property values of the second light property comprise the first property value and property values of the second light property which sequentially vary with respect to the first property value.

8. The method of claim 1, further comprising displaying a first lighting state,
wherein the light property comprises a plurality of color icons representing colors of the light, and
wherein the displaying of the lighting state comprises, if a user command for selecting at least one of the plurality of color icons is input as the user command for selecting the property value, displaying a second lighting state obtained by calculating a color corresponding to the selected color icon onto the first lighting state, instead of the first lighting state on the display unit.

9. The method of claim 1, wherein the first lighting state is a current lighting state or a previous lighting state of the lighting apparatus.

10. The method of claim 8, wherein the displaying of the second lighting state comprises:
generating a second lighting code by calculating a predetermined color code onto a first lighting code corresponding to the first lighting state; and
displaying the second lighting state corresponding to the second lighting code.

11. The method of claim 10, wherein the plurality of color icons comprise a first color icon representing a first color and a second color icon representing a second color, and
wherein each of the first and second lighting codes comprises a first code region representing the first color and a second code region representing the second color.

12. The method of claim 11, wherein, if a user command for selecting the first color icon is input, the predetermined color code is calculated onto the first code region, and
wherein, if a user command for selecting the second color icon is input, the predetermined color code is calculated onto the second code region.

13. The method of claim 8, wherein the color is red, green, or blue.

14. The method of claim 8, wherein the light property comprises a brightness icon representing a brightness level of the light, and
wherein the displaying of the lighting state further comprises, if a user command for selecting the brightness icon is input as the user command for selecting the property value, displaying a third lighting state obtained by calculating a brightness level corresponding to the selected brightness icon onto the second lighting state, instead of the second lighting state on the display unit.

15. The method of claim 14, wherein the brightness icon is displayed as at least one of black, white, and an achromatic color.

16. The method of claim 14, wherein the displaying of the third lighting state comprises:
generating a third lighting code by calculating a predetermined brightness code onto a second lighting code corresponding to the second lighting state; and
displaying the third lighting state corresponding to the third lighting code on the display unit.

17. The method of claim 16, wherein each of the second and third lighting codes comprises a first code region representing the first color and a second code region representing the second color, and
wherein, if a user command for selecting the brightness icon is input, the predetermined brightness code is calculated onto each of the first and second code regions.

18. The method of claim 1, further comprising, if a user command for requesting to execute the lighting state is input, transmitting to the lighting apparatus an execution request message for requesting to execute the determined lighting state.

19. The method of claim 1, further comprising:
if a user command for selecting the lighting apparatus is input, obtaining identification information of the lighting apparatus; and
storing the identification information of the lighting apparatus by matching the identification information to information regarding the lighting state.

20. The method of claim 1, wherein the identification information of the lighting apparatus comprises a static Internet protocol (IP) address of the lighting apparatus.

21. The method of claim 19, further comprising, if the lighting apparatus is communicable, transmitting to the lighting apparatus a message for requesting to execute the lighting state.

22. The method of claim 21, wherein the lighting apparatus is communicable via a relay apparatus.

23. The method of claim 22, wherein the relay apparatus is an access point (AP).

24. The method of claim 22, wherein the identification information of the lighting apparatus comprises identification information and port information of the relay apparatus for forwarding a port to the lighting apparatus.

25. The method of claim 24, wherein the identification information of the relay apparatus comprises a static IP address of the relay apparatus.

26. The method of claim 24, wherein the identification information of the relay apparatus comprises domain information of the relay apparatus.

27. The method of claim 21, further comprising:
receiving a message representing that the lighting state is executed, from the lighting apparatus via the relay apparatus; and
displaying on the display unit an indicator representing that the lighting state is completely executed.

28. The method of claim 21, further comprising, if the communication with the lighting apparatus is disconnected, displaying on the display unit an indicator representing that the execution of the lighting state is terminated.

29. A control apparatus comprising:
a display unit for displaying on a display unit at least one light property representing a property of light of a lighting apparatus;
a user input unit for receiving a user command for selecting a lighting state of the lighting apparatus; and
a control unit for, if a user command for selecting a property value of the light property is input, displaying a lighting state corresponding to the selected property value on the display unit and, if a user command representing that selection is completed is input, determining the displayed lighting state as the lighting state of the lighting apparatus.

30. The control apparatus of claim 29, wherein the light property is information regarding color, brightness, color temperature, or dimming cycle of the light emitted from the lighting apparatus.

31. The control apparatus of claim 29, wherein the control unit displays a current lighting state of the lighting apparatus on the display unit.

32. The control apparatus of claim 29, wherein the light property is displayed as a plurality of property values corresponding to the light property.

33. The control apparatus of claim 29, wherein the light property comprises a first light property and a second light property, and
wherein, if a user command for selecting a first property value of the first light property is input, the control unit displays a plurality of property values of the second light property related to the first property value on the display unit.

34. The control apparatus of claim 33, wherein the first light property is color, and the second light property is brightness.

35. The control apparatus of claim 33, wherein the plurality of property values of the second light property comprise the first property value and property values of the second light property which sequentially vary with respect to the first property value.

36. The control apparatus of claim 29, wherein the light property comprises a plurality of color icons representing colors of the light,
wherein a first lighting state is displayed on the display unit, and
wherein, if a user command for selecting at least one of the plurality of color icons is input as the user command for selecting the property value, the control unit displays a second lighting state obtained by calculating a color corresponding to the selected color icon onto the first lighting state, instead of the first lighting state on the display unit.

37. The control apparatus of claim 29, wherein the first lighting state is a current lighting state or a previous lighting state of the lighting apparatus.

38. The control apparatus of claim 37, wherein the control unit generates a second lighting code by calculating a predetermined color code onto a first lighting code corresponding to the first lighting state, and displays the second lighting state corresponding to the second lighting code.

39. The control apparatus of claim 38, wherein the plurality of color icons comprise a first color icon representing a first color and a second color icon representing a second color, and
wherein each of the first and second lighting codes comprises a first code region representing the first color and a second code region representing the second color.

40. The control apparatus of claim 39, wherein, if a user command for selecting the first color icon is input, the control unit calculates the predetermined color code onto the first code region, and
wherein, if a user command for selecting the second color icon is input, the control unit calculates the predetermined color code onto the second code region.

41. The control apparatus of claim 36, wherein the light property comprises a brightness icon representing a brightness level of the light, and
wherein, if a user command for selecting the brightness icon is input as the user command for selecting the property value, the control unit displays a third lighting state obtained by calculating a brightness level corresponding to the selected brightness icon onto the second lighting state, instead of the second lighting state on the display unit.

42. The control apparatus of claim 41, wherein the brightness icon is displayed as at least one of black, white, and an achromatic color.

43. The control apparatus of claim 41, wherein the control unit generates a third lighting code by calculating a predetermined brightness code onto a second lighting code corresponding to the second lighting state, and displays the third lighting state corresponding to the third lighting code on the display unit.

44. The control apparatus of claim 43, wherein each of the second and third lighting codes comprises a first code region representing the first color and a second code region representing the second color, and
wherein, if a user command for selecting the brightness icon is input, the control unit calculates the predetermined brightness code onto each of the first and second code regions.

45. The control apparatus of claim 29, wherein, if a user command for requesting to execute the lighting state is input, the control unit transmits to the lighting apparatus an execution request message for requesting to execute the determined lighting state.

46. The control apparatus of claim 29, wherein, if a user command for selecting the lighting apparatus is input, the control unit obtains identification information of the lighting apparatus, and stores the identification information of the lighting apparatus by matching the identification information to information regarding the lighting state.

47. The control apparatus of claim 29, wherein the identification information of the lighting apparatus comprises a static Internet protocol (IP) address of the lighting apparatus.

48. The control apparatus of claim 47, wherein, if the lighting apparatus is communicable, the control unit transmits to the lighting apparatus a message for requesting to execute the lighting state.

49. The control apparatus of claim 48, wherein the lighting apparatus is communicable via a relay apparatus.

50. The control apparatus of claim 49, wherein the relay apparatus is an access point (AP).

51. The control apparatus of claim 49, wherein the identification information of the lighting apparatus comprises identification information and port information of the relay apparatus for forwarding a port to the lighting apparatus.

52. The control apparatus of claim 51, wherein the identification information of the relay apparatus comprises a static IP address of the relay apparatus.

53. The control apparatus of claim 51, wherein the identification information of the relay apparatus comprises domain information of the relay apparatus.

54. The control apparatus of claim 48, wherein, if a message representing that the lighting state is executed is received from the lighting apparatus via the relay apparatus, the control unit displays on the display unit an indicator representing that the lighting state is completely executed.

55. The control apparatus of claim 48, wherein, if the communication with the lighting apparatus is disconnected, the control unit displays on the display unit an indicator representing that the execution of the lighting state is terminated.

56. The control apparatus of claim 29, wherein the control apparatus is a mobile device.
